(19) United States
(12) Patent Application Publication
(10) Pub. No.: US 2026/0359222 A1
(43) Pub. Date: Nov. 12, 2026

(54) SYSTEM AND METHOD TO ACCESS AI MODELS AND DATASETS IN KUBERNETES

(71) Applicant: Rafay Systems, Inc., Sunnyvale, CA (US)

(72) Inventors: Rajat Tiwari, Thane (IN); Ayush Thakur, Gurgaon (IN); Hanumantha Rao Kavuluru, San Jose, CA (US); Sashidhar Reddy Polu, Bangalore (IN)

(73) Assignee: Rafay Systems, Inc., Sunnyvale, CA (US)

(21) Appl. No.: 19/668,576

(22) Filed: May 5, 2026

Related U.S. Application Data
(60) Provisional application No. 63/800,555, filed on May 6, 2025.

(51) Int. Cl. G06F 12/0811; G06F 12/084

(52) U.S. Cl. CPC G06F 12/0811; G06F 12/084

(57) ABSTRACT

A distributed computing system to run an application that uses information stored in one or backend storage memories (BSMs) that use different application programming interfaces (APIs) to provide access over a network to the stored information comprising: a cluster with multiple worker nodes; wherein each worker node includes an L1 cache; a storage gateway (SG); and multi-API logic; wherein the SG is configured to return information from one of the L1 cache, the L2 cache, and a BSM, in response to a file operation issued by an application running on the cluster; and wherein the multi-API logic is configured to use one of multiple BSM APIs to return information to the SG in response to a file operation issued by the application.

### RELATED APPLICATIONS

This application claims the benefit of U.S. Provisional Patent Application No. 63/800,555, filed on May 6, 2025, and entitled “System and Method to Access AI Models and Datasets in Kubernetes”, the contents of which are incorporated herein by reference in their entirety.

### BACKGROUND

The increasing complexity of accessing and managing large Artificial Intelligence (AI) models and datasets across fragmented storage landscapes, including cloud and on-premises, can hinder the efficiency and scalability of AI workloads, particularly in Kubernetes environments. AI practitioners face challenges with vendor lock-in, inconsistent access methods, slow data retrieval, and difficulties in supporting demanding multi-GPU workloads that require quick autoscaling.

AI teams often have data scattered across various storage systems. Current approaches often lack a unified interface to access these disparate sources, leading to complex configurations, vendor lock-in, and operational overhead. Developers often must learn and manage different APIs and access methods for each storage type.

Treating models and datasets as standard Kubernetes volumes is often not consistently and efficiently implemented across storage providers. Existing volume mounting solutions can be cumbersome to configure for cloud storage or lack features optimized for AI workloads. Making models and datasets easily accessible as volumes within pods can simplify application development and integration with the Kubernetes ecosystem.

Downloading large models and datasets from remote storage for each workload execution can be slow and resource intensive. Model caching can mitigate this bottleneck, but current solutions often lack integrated and intelligent caching mechanisms within Kubernetes that are aware of AI workload access patterns.

Beyond static multi-GPU setups, autoscaling introduces further data access complexities. Modern AI workloads, especially large language models, often require dynamically adding or removing GPU nodes, rapid data provisioning to new instances, and efficient redistribution for training and inference use cases. Existing solutions often are not optimized for the high-bandwidth, low-latency data access required for distributed model parallelism, which can result in performance degradation during scaling events.

### SUMMARY

The present disclosure relates generally to systems and methods for accessing and managing artificial intelligence (AI) applications, models and datasets in Kubernetes environments, and more particularly to distributed computing systems that provide efficient, scalable, and version-aware access to models and data across multiple worker nodes.

In one aspect, a distributed computing system is provided that includes a Kubernetes cluster having multiple worker nodes. Each worker node includes a local cache (L1 cache), and the cluster further includes a shared cache (L2 cache). One or more pods running on the worker nodes include containers configured to execute applications and a storage gateway. The storage gateway is configured to return information requested by an application from one of the L1 cache, the L2 cache, or a backend storage memory selected from among multiple backend storage memories that expose different application programming interfaces (APIs). The storage gateway further includes multi-API logic that enables use of different backend storage APIs to retrieve information without requiring the application to natively support those APIs.

In another aspect, the disclosure provides a distributed computing system in which a single pod may be associated with multiple persistent volumes, each mounted at a different mount point path and each bound to a different backend storage configuration identifying a corresponding backend storage memory. A respective user-space filesystem instance is instantiated for each persistent volume to intercept file operations issued at file paths beneath the mount point at which the persistent volume is mounted. File operations issued by an application are routed, based on the mount point path at which the file operation is directed, through the corresponding user-space filesystem instance to a storage gateway, which resolves the file operation to a backend storage memory using the backend storage configuration bound to the associated persistent volume. This arrangement enables a single application to transparently access multiple backend storage systems through conventional file operations, while allowing the storage gateway to deterministically select the appropriate backend storage memory without requiring backend identification information to be encoded in the file operations themselves.

In another aspect, methods are disclosed for auto scaling an inference application in a distributed computing system. In one example, a first instance of an inference application executes in a first pod on a worker node and obtains at least a portion of a model from a backend memory system, which is stored in a first cache that is exclusively accessible to pods running on that worker node. While the first instance is executing, a second pod running a second instance of the inference application is spun up on the same worker node, and the second instance accesses the cached model portion from the first cache for execution, thereby avoiding repeated retrieval of the model portion from backend storage.

In another example of inference application auto scaling, a first instance of an inference application executes in a first pod on a first worker node and stores at least a portion of a model in a shared cache that is accessible to multiple worker nodes of the cluster. While the first instance is executing, a second pod running a second instance of the inference application is spun up on a second worker node. The second instance accesses the shared cache to obtain the model portion and uses the model portion during execution, thereby accelerating scaling across worker nodes.

In a further aspect, methods are disclosed for checkpointing a fine-tuning application in a distributed computing system. A pod executing a fine-tuning application periodically stores checkpoints of a model in a cache memory while the fine-tuning application continues to execute. The checkpoints are uploaded from the cache memory to a backend storage memory, enabling reduced interruption to fine-tuning operations and facilitating recovery or reuse of checkpoints.

In another aspect, a distributed computing system is provided for processing different versions of a model or dataset stored in a backend storage system. The system includes a cluster having a first pod that includes a first persistent volume mounted to a first path and executes a first instance of an application, and a second pod that includes a second persistent volume mounted to a second path and executes a second instance of the application. A storage gateway is configured to return information from different memory locations in the backend storage system in response to file operations issued by the respective application instances, thereby enabling different application instances to operate concurrently on different versions of a model or dataset without requiring repeated downloading or duplication of backend data.

### BRIEF DESCRIPTION OF THE DRAWINGS

Aspects of the present disclosure are best understood from the following detailed description when read with the accompanying figures. It is emphasized that various features are not drawn to scale in accordance with the standard practice. In fact, the dimensions of the different features may be arbitrarily increased or reduced for clarity of discussion. In addition, the present disclosure may repeat reference numerals and/or letters in the various examples. This repetition is for simplicity and clarity and does not in itself dictate a relationship between the various embodiments and/or configurations discussed.

FIG. 1 is an illustrative drawing representing an example Kubernetes cluster.

FIG. 2 is an illustrative drawing of a distributed computing system comprising a Kubernetes cluster.

FIG. 3 is an illustrative simplified diagram showing additional details of the example worker node of FIG. 2.

FIG. 4 is an illustrative drawing representing operations performed using an example USFS of a worker node of FIG. 2 or 3.

FIG. 5A is an illustrative drawing representing multiple PVs configured within a pod of the system of FIG. 2 or 3.

FIG. 5B is an illustrative diagram representing an example process to complete a file operation using the system of FIGS. 2-3.

FIG. 6 is an illustrative drawing representing a file that includes a data section and a metadata section.

FIG. 7 is an illustrative function diagram showing a succession of set up and read cycles involving the first worker node and the second worker node.

FIG. 8 is an illustrative drawing representing a computing machine that can be configured to operate as a cluster node.

### DETAILED DESCRIPTION

### Kubernetes Cluster Example

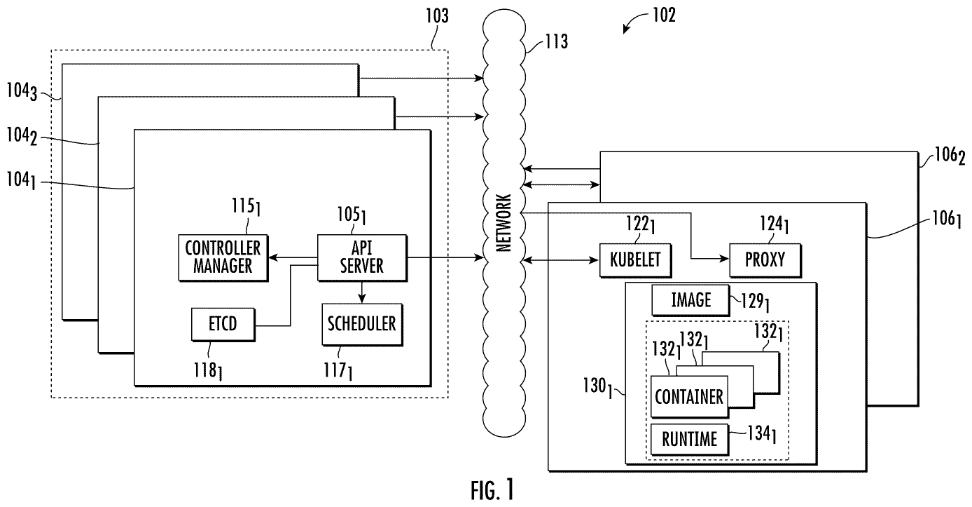

FIG. 1 is an illustrative drawing showing an example Kubernetes cluster 102 including first, second, and third control plane nodes 104₁, 104₂, 104₃ within a control plane 103 and first and second worker nodes 106₁-106₂. The control plane 103 includes multiple control plane nodes 104₁, 104₂, and 104₃ to enable load balancing and redundancy. For the sake of economy of disclosure, reference will be made primarily to Kubernetes components on the first control plane node 104₁ and the first worker node 106₁. The similar operation of the second and third control plane nodes 104₂ and 104_{3,} and of the second worker node 106₂, will be readily understood from the disclosure. Only three control plane nodes, 104₁, 104₂, and 104₃, and two worker nodes, 106₁ and 106₂, are shown. However, a Kubernetes cluster 102 can include many more nodes. A typical Kubernetes cluster includes hundreds of cluster nodes, for example.

Cluster nodes 104₁-104₃, 106₁, and 106₂ are hosted on physical or virtual machines configured with machine-readable instructions to implement Kubernetes components, which can run within pods. Kubernetes components of an example control plane node 104₁ include an API (application programming interface) server 105₁, a “kube” controller manager server 115₁, a scheduler 117₁, and an etcd store 118₁ Kubernetes components of an example worker node 106₁ include a pod management agent (commonly referred to as a “kubelet”) 122₁, a network proxy server 124₁ (commonly referred to as a “kube-proxy”), and one or more pods 130₁ that can run containerized applications as services within one or more containers e.g., container 132₁ within one or more pods e.g., pod 130₁. A containerized application 131₁ can span multiple containers 132₁, each of which may execute a part of the application 131₁. A kubelet instance can run at each node in the cluster 102, to manage pods, although only one is shown in the drawing. Kubernetes components of the cluster 102, which themselves run in containers in pods, can communicate over a network 113 with one another and/or with entities outside the cluster 102 using a network protocol such as HTTPS.

Referring to control plane node 104₁, the API server 105₁ can operate as an interface between the control plane node 104₁ and the worker node 106₁. The API server 105₁ can also operate as an interface for storing data to and retrieving data from etcd store 118₁. The etcd store 118₁ can operate as a primary data store for the cluster 102, storing configuration information used to determine the entire state of the Kubernetes cluster, including information about nodes, pod specifications, services, network configurations, and security settings. Kube controller manager 115₁ can operate to monitor the etcd store 118₁ for state changes and to use the API server 105₁ to orchestrate provisioning of new cluster nodes and deletion of existing cluster nodes depending upon service or user requirements or workload demand, for example, and to cause adjustments to nodes (e.g., worker nodes 106₁ and 106₂) and pods (e.g., pod 130₁) within the cluster 102 to ensure that the current cluster state matches the desired cluster state. Scheduler 117₁ can operate to read cluster data from the etcd store 118₁ and to decide where to place new pods among nodes of the cluster 102.

Referring to worker node 106₁, kubelet 122₁ acts as a client of the API server 105₁, communicating with it in a control loop to send and receive information to enforce a desired state of the worker node 106₁, and also operates to ensure that containers 132₁ in a pod 130₁ at node 106₁ are running and healthy. Kube-proxy 124₁ maintains network rules on the worker node 106₁ (e.g., via iptables, IPVS, or eBPF) to manage the routing of network traffic between services. Kube-proxy 124₁ supports direct communication between container-based services running in the cluster 102. More specifically, kube-proxy 124₁ provides routing information that enables a packet from a service on one worker node to be sent directly to the IP address of another service running in a pod on the same worker node or in a pod on a different worker node. Services may contact a control plane node 104₁, for example, to access a control plane service, such as IP discovery and registration to determine the locations of other services within cluster 102.

A container 132₁ is a runtime interface unit created using a container runtime 134₁ (e.g., containerd) that implements the Container Runtime Interface (CRI) from a container image 129₁, that executes software that is isolated from other containers (e.g., different namespaces, cgroups) inside a pod 130₁. A container's 132₁ runtime 134₁ uses a host worker node's operating system (not shown) to execute. A container image 129₁ acts as a blueprint or read-only template, which does not execute by itself, that bundles information that can include application binaries or source code, runtime, libraries, and dependencies, filesystem layout, and entry point. A container runtime 134₁ comprises computer program code that provides a container-execution framework, enabling execution of a container 132₁ running an instance of a container image 129₁ using the operating system of a cluster node, such that a container 132₁ runs as an operating system process.

Example pod 130₁ includes multiple containers 132₁ that share the computational resources of a node in which they are instantiated. The kubelet 122₁ monitors the execution of pod 130₁ and observes the pod's specification via the Kubernetes API server 105₁, to determine whether the containers 132₁ are running and healthy. For example, kubelet 122₁ can receive a specification (e.g., a “PodSpec”) from the API server 105₁ (e.g., a YAML file or JSON object) that defines the desired state and configuration of pod 130₁. A pod specification can define containers 132₁ that run within a pod, including application program code, runtime, commands, and arguments. The pod specification can also define shared resources available for its use including processor resources and storage memory resources, such as storage volumes that the pod will use, including persistent storage volumes and ephemeral storage volumes, for example. The kubelet 122₁ can use the pod specification as a basis to communicate with container runtimes 134₁ to start, stop, and manage containers 132₁ within a pod 130₁ and to ensure that the containers 132₁ are running, healthy, and in the desired state on the worker node 106₁. The kubelet 122₁ at the worker node 106₁ can report the status of containers 132₁ back to the control plane node 104₁ via the API server 105₁. An API server 105₁ running on a designated lead control plane node 104₁ acts as a communication interface for communicating with kubelet 122₁ on worker node 106₁.

### Kubernetes PVCs, PVs, and CSIs

The creation and binding of a Persistent Volume Claim (PVC) and a Persistent Volume (PV) are primarily handled by a control plane node 104₁. For example, kube controller manager 115₁ of the control plane node 104₁ can manage these processes. A PV comprises a storage object created at the request of a user or service and allocated for use within a cluster 102. A PV object can include storage capacity, access modes, container storage interface (CSI) driver details, endpoint, storage class, and bucket information. Different volumes can be allocated to different types of physical storage (e.g., local disk on a node, iSCSI, NFS, cloud storage, etc.). A PV object specifies a CSI driver to use to access the allocated storage. A PVC object includes a storage request (e.g., “I need 10 Gi of storage that supports ReadWriteMany access modes, and a specified storage class”). For example, a pod, which may include an application with one or more services running (i.e., by executing instructions) in one or more containers, can be associated with a PVC object. The PVC object is used to request storage resources for use by the application. A PVC starts in a Pending state. Controller manager 115₁ continuously monitors Pending PVCs and available PVs. When the kube controller manager 115₁ finds a PV that satisfies the requirements of a PVC required for an application (e.g., the same storage class, compatible access modes, sufficient capacity), it binds the PVC to the PV. Mounting of the PV onto the pod that will use it is subsequently performed by the kubelet on the worker node where the pod is scheduled, via a CSI driver, as described in the next section. For example, a PV storing a model used by an artificial intelligence (AI) application can be mounted to a directory accessible to the AI application running in a pod using a path name used to store model weights or models, such as, /mnt/weights or/mnt/models. The AI application can access the PV via the path name. The controller manager 116 updates the status of both the PVC (to Bound) and the PV (to Bound), linking them via references in their object definitions. As explained more fully below a pod can be associated with multiple PVs. An application can use different path names to access different PVs.

### Kubernetes Use of a CSI to Mount a PV

A Kubernetes cluster 102 can use a CSI driver to mount a volume to a specific path in a cluster node. A Kubernetes pod specification can include a volumes section that includes a volume mount request that references a PVC by name. When scheduler 117₁ places the pod onto a specific worker node, e.g., worker node 106₁, a kubelet 122₁ on the worker node can read the pod specification and see the volume mount request referencing the PVC. The kubelet 122₁ can check the PVC's status, and assuming that the PVC is already bound to a PV, the kubelet 122₁ can use the information in the bound PV object to learn which CSI driver to call. The kubelet 122₁ can call a node-local CSI driver, e.g., NodePublishVolume endpoint, and provide the PV's volume details and a target mount path inside the pod (e.g., /mnt/weights or/mnt/models) to specify the mount point through which the CSI driver can communicate with the Kubernetes cluster 102. A pod specification can include multiple volume mount requests, each one independently referencing its own PVC. Each PVC can be bound to a different PV as explained above. Thus, multiple PVs can be bound to a single pod.

### Provisioning, Scheduling, and Executing Workloads/Applications

Provisioning worker node 106₁, for example, typically includes creating a compute instance with an operating system (e.g., Linux) and container runtime 134₁, and installing and bootstrapping Kubernetes worker node infrastructure components that exist independently of user workloads, including kubelet 122₁, kube-proxy 124₁, and a container runtime network interface (CNI) (not shown) to enable pod-to-pod and pod-to-service networking. The kubelet 122₁ contacts the API server 105₁ to enable networking and workload scheduling.

Scheduling a workload/application is the process of selecting a suitable worker node for a pod and binding that pod to the node, after which the worker node's local components create a runtime environment to execute it. A pod object that includes a container image and resource requests is initially created using an API server 105₁ at the control plane node 104₁, for example. The pod object is initially stored in etcd storage 118₁ and marked as pending. Scheduler 117₁ detects the pod object, selects a worker node, e.g., worker node 106_{1,} and causes the API server 105₁ to bind the pod to a selected worker node.

Workload execution typically starts after the pod is bound to a selected worker node, e.g., worker node 106₁. The kubelet 122₁ on the chosen worker node observes the assignment and begins pod execution, which can include downloading a container image referenced in the pod's specification, creating containers, setting up CNI, and attaching storage (CSI). Whereupon the workload is ready to execute.

The combination of provisioning, scheduling, and starting execution is referred to herein as “spinning up” a pod.

### Memory Access System

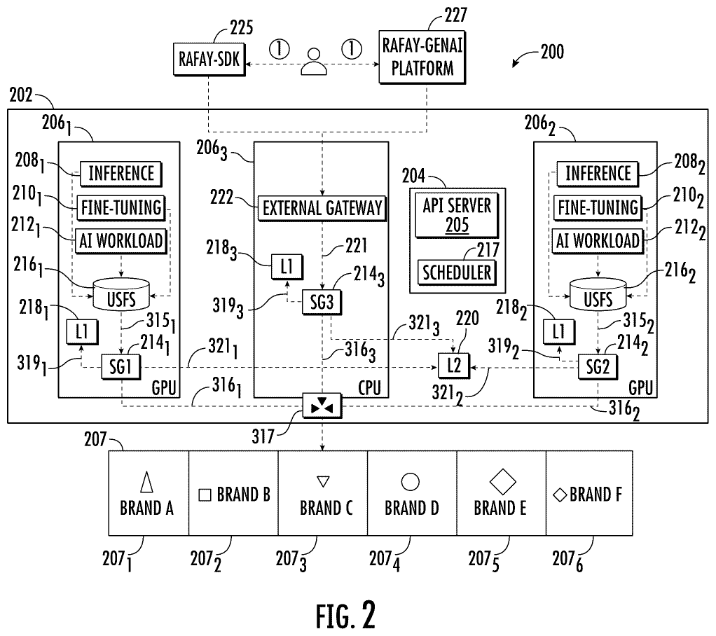

FIG. 2 is an illustrative drawing of a distributed computing system 200 comprising a Kubernetes cluster 202. The example cluster 202 is based on the Kubernetes cluster topology shown in FIG. 1 and comprises a control plane node 204 and first, second, and third worker nodes 206₁-206₃. The control plane node 204 and the worker nodes 206₁-206₃ of the cluster 202 can include Kubernetes components shown in FIG. 1, which are not shown in FIG. 2. Each worker node 206₁-206₃ includes a respective local cache, referred to herein as a level one cache (“L1 cache”) 218₁-218₃, each of which is individually accessible to its respective worker node. The cluster 102 is communicatively coupled to a shared cache storage, referred to herein as a level two cache (“L2 cache”) 220 that is mounted to, and therefore, accessible to each of the worker nodes. FIG. 2 shows only a single USFS 216₁, a single USFS 216₂, and a single USFS 216₃, in each of worker nodes 206₁, 206₂, and 206₃. However, as explained in more detail below, a fully configured worker node 206₁ or 206₂, or 206₃ has multiple USFSs.

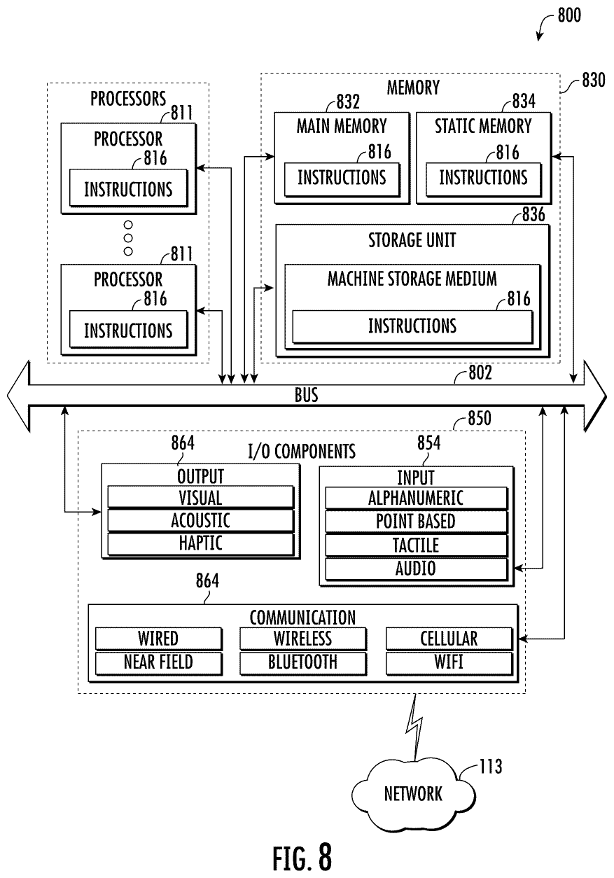

A first worker node 206₁ comprises compute instance that include a physical or virtual machine such as computing machine 800 shown in FIG. 8 that includes one or more processing units 811 operatively coupled to non-transitory memory 830 to store executable instructions, which comprise one or more graphical processor units (GPUs) or tensor processing units (TPUs), for example, that can be configured to run AI applications that operate using neural network models. First worker node 206₁ is configured to include one or more pods that use containers to execute AI application program instructions. The first worker node 206₁ includes a pod including one or more containers (not shown) configured to run a first AI inference application 208₁, a pod including one or more containers (not shown) configured to run a first AI fine-tuning application (e.g., model training) 210₁, and a pod including one or more containers (not shown) configured to run a first AI workload application (e.g., to execute an SDK-based user AI workload) 212₁. The first worker node 206₁ includes a pod including one or more containers (not shown) configured to implement a first storage gateway (SG1) service instance 214₁. The first worker node 206₁ includes a pod including one or more containers (not shown) configured to run a first user-space filesystem instance (USFS) 216₁ instance. The first worker node 206₁ includes a pod including one or more containers (not shown) configured to run a first local cache storage (L1 cache) 218₁, which can comprise fast-access memory such as RAM or SSD.

A second worker node 206₂ comprises a compute instance that include a physical or virtual machine, such as computing machine 800 shown in FIG. 8, which includes one or more processing units 811 operatively coupled to non-transitory memory 830 to store executable instructions, which comprise one or more GPUs or TPUs, for example, that can be configured to run AI applications that operate using neural network models. The second worker node 206₂ is configured to include one or more pods that use containers to execute AI application program instructions. The second worker node 206₂ includes a pod (not shown) that includes one or more containers (not shown) configured to run a second AI inference application 208₂, a pod (not shown) that includes one or more containers (not shown) configured to run a second AI fine-tuning application (e.g., model training) 210₂, and a pod (not shown) that includes one or more containers (not shown) configured to run a second AI workload application (e.g., to execute an SDK-based user AI workload) 212₂. The second worker node 206₂ includes a pod (not shown) that includes one or more containers (not shown) configured to implement a second storage gateway (SG2) service instance 214₂. The second worker node 206ₛ includes a pod (not shown) that includes one or more containers (not shown) configured to run a second USFS 216₁ instance. The second worker node 206₂ includes a pod (not shown) that includes one or more containers (not shown) configured to run a second local cache storage (L1 cache) 218₂, which can comprise fast-access memory such as RAM or SSD.

The AI inference applications 208₁, 208₂, fine-tuning applications 210₁, 210₂, and workload services 212₁, 212₂, that run at the first and second worker nodes 206₁ and 206₂ perform information processing that uses neural network models (“models”) and also may use training data (“datasets”). These AI applications (sometimes referred to in Kubernetes as “services”) can use models, such as large language models (LLMs) that utilize the transformer architecture. It is contemplated that alternatively, the AI applications can perform information processing using Convolutional Neural Network models (CNNs) and Recurrent Neural Network (RNN) models. For example, an AI inference application 208₁ or 208₂ can use a model to generate responses or predictions based on new input data. An AI fine-tuning application 210₁ or 210₂ can train or adjust a pre-trained model to improve performance on a specific task or within a particular domain. An example AI workload application 212₁ or 212₂ can use a trained model for a particular task, such as statistical analysis, data preprocessing, model evaluation against test datasets, or batch inference jobs, for example.

The first and second worker nodes 206₁ and 206₂ can run different combinations of AI applications. For example, a first AI inference application 208₁ running on the first worker node 206₁ can differ from a second AI inference application 208₂ running on the second worker node 206₂. Moreover, different combinations of AI applications can run on different worker nodes. For example, the first worker node 206₁ may run multiple AI inference applications, and the second worker node 206₂ may run only a single AI fine-tuning application and no other AI applications.

A third worker node 206₃ comprises a compute instance that include a physical or virtual machine such as computing machine 800 shown in FIG. 8 with one or more processor circuits 811 operatively coupled to non-transitory memory 830 that stores instructions that execute in containers within pods to configure the processor circuits to implement an external gateway 222 and a third storage gateway (SG3) service instance 214₃. External gateway 222 operates as an entry point for user or application requests to use inference, fine-tuning, and/or workload instances running in the cluster 202 to run models and/or to specify datasets for model execution. External gateway 222 performs authentication and authorization on these requests to ensure that only valid and permitted requests are processed. External gateway 222 can be used to create network connections with a first external interface 225, which can be an SDK user interface used to programmatically upload, download, list, or manage versions of models and datasets stored within the system, for example. External gateway 222 can also form network connections with a second interface 227, which can be a GenAI platform user interface used to access generative AI systems (e.g., DeepSeek, Llama 2, or Stable Diffusion). The third worker node 206₃ includes a third co-located local cache storage (“L1 cache”) 218₃, which can comprise fast-access memory such as RAM or SSD.

SG1 214₁, SG2 214₂, and SG3 214₃ are instances of a system-level storage gateway service. SG1 214₁, SG2 214₂, and SG3 214₃ that run on the worker nodes 206₁, 206₂, and 206₃ control access to the L1 caches 218₁-218₃, L2 cache 220, and a backend storage memory system (BSMS) 207. As used herein, “access” to memory refers to an operation to read information from or to write information to a memory (e.g. L1 cache, L2 cache, or a BSM). SG1 214₁, SG2 214₂, and SG3 214₃ control exclusive access by AI applications or services running at worker nodes, 206₁, 206₂, and 206₃, to respective local L1 caches 218₁, 218₂, and 218₃. SG1 214₁, SG2 214₂, and SG3 214₃ control shared access by AI applications or services running at worker nodes, 206₁, 206₂, and 206₃, to L2 cache 220. SG1 214₁, SG2 214₂, and SG3 214₃ are mounted to an L2 network filesystem (NFS) 326, which provides shared access to the L2 cache 220. The L2 NFS's protocol allows applications or services running on worker nodes 206₁-206₃ to access and manage files on a remote L2 storage server (i.e., L2 cache) as if they were stored locally. Services running on worker nodes 206₁, 206₂, and 206₃ can also access the backend memory 207. SG1 214₁, SG2 214₂, and SG3 214₃ control shared access by AI applications or services running at worker nodes, 206₁, 206₂, and 206₃, to BSMS 207, which can be a distributed system that includes multiple individual third party backend storage memories (BSMs) 207₁-207₆ that can have different APIs (e.g., BSM API₁-BSM API₆) that can be cloud-based and/or on-premises. More specifically, SG1 214₁, SG2 214₂, and SG3 214₃ control shared access by AI applications or services running at worker nodes, 206₁, 206₂, and 206₃, to multi-API logic 317 used to implement respective APIs used to communicate over a network 113 such as the internet, with respective BSMs 207₁-207₆. Each third-party BSM 207₁-207₆ may be managed by a different information provider to store different information (e.g., different models or datasets) and may require use of a provider-prescribed backend API to communicate over the network 113. For example, different backend APIs can include one or more of the S3 API used by AWS S3/MinIO/Ceph, filesystems like WekaFS, or specific cloud APIs like Google Cloud Storage (GCS) and Azure Blob Storage, for example, and that can be cloud-based and/or on-premises. Different BSMs can use the same API but different network addresses for memory access. The multi-API logic 317 is configured to implement multiple different APIs, each used to communicate with one or more of BSMs 207₁-207₆ of the BSMS 207

A Kubernetes DaemonSet process runs in the background on each worker node 206₁-206₃ to ensure that SG1-SG3 214₁-214₃ are deployed and properly running on each node. For example, the Kubernetes DaemonSet process ensures that each AI application running on a worker node has the required mount system so it can access its local L1 cache, the shared L2 cache, and the BSMs 207₁-207₆ of the BSMS 207.

Dashed lines 315₁ indicate that SG1 214₁ is communicatively coupled with the first user-space filesystem (USFS) instance 216₁. Dashed lines 319₁ indicate that pods of the first worker node 206₁ are configured to communicatively couple SG1 214₁ with the first L1 cache 218₁. Dashed lines 321₁ indicate that pods of the first worker node 206₁ are configured to communicatively couple SG1 214₁ with the L2 cache 220. Dashed lines 316₁ indicate that pods of the first worker node 206₁ are configured to communicatively couple multi-API logic 317 with SG1 214₁. Dashed lines 315₂ indicate that pods of the second worker node 206₂ are configured to communicatively couple SG2 214₂ with the second USFS 216₂. Dashed lines 319₂ indicate that pods of the second worker node 206₂ are configured to communicatively couple SG2 214₂ with the second L1 cache 218₂. Dashed lines 321₂ indicate that pods of the second worker node 206₂ are configured to communicatively couple SG2 214₂ with the L2 cache 220. Dashed lines 316₂ indicate that pods of the second worker node 206₂ are configured to communicatively couple multi-API logic 317 with SG1 214₂.

Dashed lines 221 indicate that pods of the third worker node 206₃ are configured to communicatively couple SG3 214₃ with the external gateway 222, which is configured to communicatively couple with first and/or second external user interfaces 225, 227.

Each of SG1 214₁ and SG2 214₂ is configured to receive network API requests via corresponding USFS 216₁ and USFS 216₂. SG3 214₃ is configured to receive network API requests via external gateway 222. An SG instance, SG1, SG2, or SG3 , that receives an API request is configured to first check whether information subject to the requested operation is available at a corresponding local L1 cache 218₁, 218₂, or 218₃. If the information is available in the corresponding local L1 cache (cache hit), the SG instance that receives the request uses the local L1 cache to complete the request.

If the information subject to the API request is not available in the corresponding L1 cache (cache miss) the SG instance that receives the request is configured to check whether the information is available in the shared L2 cache 220. If the information is available in L2 cache 220 (cache hit), the SG instance that receives the request is configured to use the L2 cache 220 to complete the request and also stores information obtained from the L2 cache in a local L1 cache at the worker node where the receiving SG runs. For example, if SG1 214₁ uses the L2 cache 220 to complete the request, then the first storage gateway SG1 214₁ stores the information obtained from the L2 in the first L1 cache 218₁.

If the requested information is not available at the L2 cache 220 (cache miss), then an SG instance that receives the API request identifies a BSM to complete the request and uses the multi-API logic 317 to implement a network protocol used by the identified BSM to communicate with the BSM during completion of the request. The SG instance that receives the request is also configured to store information obtained from the identified BSM in a corresponding local L1 and in the shared L2 cache. For example, if the first storage gateway SG1 214₁ uses a BSM from the BSMS 207 to complete a request, then the first storage gateway SG1 214₁ stores information obtained from the identified BSM in the first L1 cache 218₁ and in the L2 cache 220.

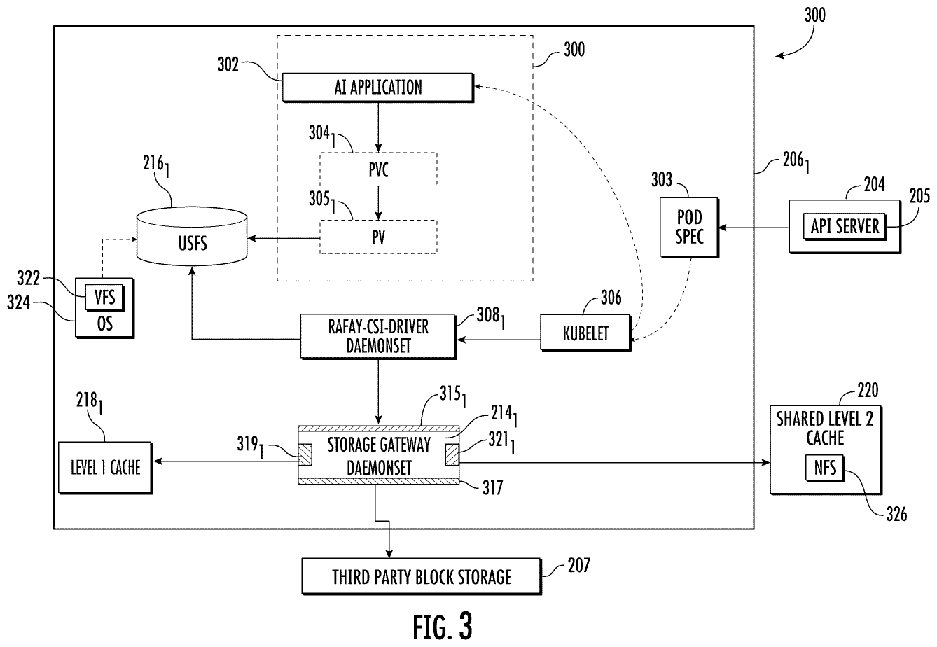

FIG. 3 is an illustrative simplified diagram showing additional details of the example first worker node 206₁ of FIG. 2. The first worker node 206₁ includes a pod 300 with one or more containers (not shown) configured with instructions to run an AI application 302, a pod including one or more containers (not shown) configured with instructions to run the first USFS 216₁, a pod including one or more containers (not shown) configured with instructions to run SG1 214₁, a pod including one or more containers (not shown) configured with instructions to run Kubelet 306, and the L1 cache 218₁. FIG. 3 is referred to as simplified since it shows only a single PVS 304₁, a single PV 305₁, a single USFS 216₁, and a single CSI driver 308 so as to more clearly and simply illustrate their functional relationship. However, as explained more fully below, a fully configured worker node 206₁ or 206₂ has multiple sets of instances of these components.

API server 205 at control plane node 204 and Kubelet 306 at first worker node 206₁ communicate to control the configuration of the first worker node 206₁ to run the AI application 302. A scheduler 217 at the control plane node 204 assigns the AI application 302 to the worker node 206₁. API server 205 communicates with Kubelet 306 over a network 113 to provide a pod specification 303 for the AI application 302. Kubelet 306 reads the pod specification, which identifies a PVC 304₁ that is bound to a PV 305₁. PV 305₁ includes a container storage interface (CSI) driver name, a bucket name (e.g., a model name or a dataset name), an access key, and secret key credentials, which SG1 214₁ can use to authenticate requests to at least one of BSMs 207₁-207₆. Kubelet 306 determines the CSI driver name based on the reference to PVC 304₁ in the pod specification 303. Kubelet 306 calls a function, e.g., NodePublishVolume, to invoke a node-local instance of CSI driver 308, which can be a plugin.

PV 305₁ is mounted by CSI driver 308 at a specific mount point path, and USFS 216₁ instance is instantiated at the mount point path for that PV to intercept file operations issued at paths beneath it. More particularly, CSI driver 308 starts the first USFS 216₁ (e.g., a FUSE process in Linux) and mounts PV 305 to a prescribed mount point path directory within the pod 300 where the AI application 302 runs. A mount point path is the directory path inside the pod's filesystem namespace where the PV is attached. A mount point path is specified in the pod specification, created by the CSI driver during NodePublishVolume, and owned by exactly one filesystem instance. All file paths beneath this directory (e.g., /mnt/models/model.bin) resolve to the same PV. CSI driver 308 mount PV 305₁ to a mount point path (e.g., /mnt//models) having a volume file path for neural network models (e.g., /mnt/models/model.bin).

The first USFS 216₁ registers with a virtual file system (VFS) 322 of an operating system (OS) kernel 324 that runs on worker node 206₁, to intercept file operations issued by the AI application 302. As used herein, a “file operation” refers to an operating-system-level action performed by a containerized process on a mounted filesystem, such as creating, reading, writing, or deleting a file via standard file APIs (e.g., open, read, write, close), backed by a Kubernetes volume.

Kubelet 306 starts AI application 302 within the pod 300. When the application code of the AI application 302 runs and attempts a file operation (e.g., open, read, write list, etc.) on a volume file path, such as/mnt/models/model.bin, within a mount point path mounted to PV 305₁, USFS 216₁ uses the VFS 322 to intercept the file operation from the OS kernel 324, translates the file operation into an API request, and forwards to the API request to the storage gateway service 214₁. SG1 214₁ completes the API request using one of L1 cache 218₁, L2 cache 220, or one of the BSMs 207₁-207₆ and provides a corresponding return, which may include requested information, the USFS 216₁ which provides the return to the requesting application 302. A mount point path is configured so that the SG1 214₁ can point folders of a pod's volume to the correct files in BSMS 207. To support versioning, different volume paths can be used with PVs of different pods used to execute different instances of an application, such that each instance of the application can use a different version of a model or dataset stored at different memory locations in the BSMS 207 corresponding to the different volume paths. As used herein, a “return” refers to information produced by the memory system in response to a memory access request. In the context of a memory read or write operation, “return” or “return information” refers to the response generated by the memory system, comprising either the requested data in the case of a read or a completion and status indication in the case of a write.

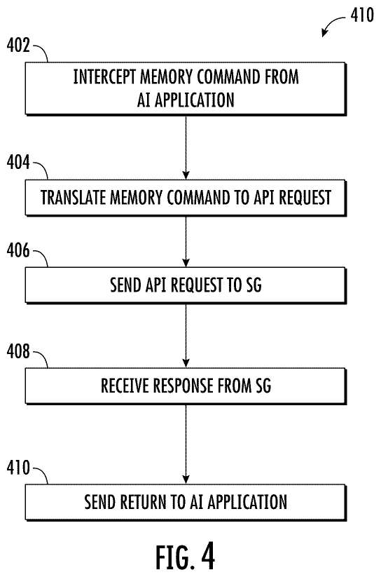

FIG. 4 is an illustrative drawing representing operations performed using a USFS of FIG. 2 or FIG. 3. The following example explanation of the flow diagram 400 refers to pod 300, AI application 302, PV 305₁, USFS 216₁, and SG1 214₁ of worker node 206₁. In operation 402, USFS 216₁ intercepts a file operation issued by the AI application 302 that is redirected from the OS kernel 324. In operation 404 USFS 216₁ translates the file operation into a network API request. As used herein, a “network API request” refers to a self-contained service invocation issued over a network interface, rather than an operating-system file I/O operation performed on a mounted filesystem. An example network API request defines a network operation (e.g., use HTTP) and a method (e.g., GET', DELETE', PUT', LIST') to operate on a storage resource. In operation 406, USFS 216₁ sends the network API request to SG1 214₁, which completes the quest using one of L1cache 218₁, L2 cache 220, or one of the BSMs 207₁-207₆, as explained above. An example SG1 214₁ includes a communication network layer service for data exchange between the USFS 216₁ and the L1 cache 218₁, L2 cache 220, and the BSMs 207₁-207₆. More particularly, an example first SG1 214₁ is configured to use a service named S3 (Simple Storage Service), which provides a data exchange service that uses object storage over a network and supports a network API with methods including PUT, GET, DELETE, and LIST. In operation 408, USFS 216₁ receives return information (e.g., a model or a dataset) from SG1 214₁ in response to the network API request. In operation 410, USFS 216₁ provides the return information responsive to the memory command to a volume path under a prescribed mount point path (e.g., /mnt//models) of PV 305₁ associated with pod 300 where the AI application 302 can access the return information.

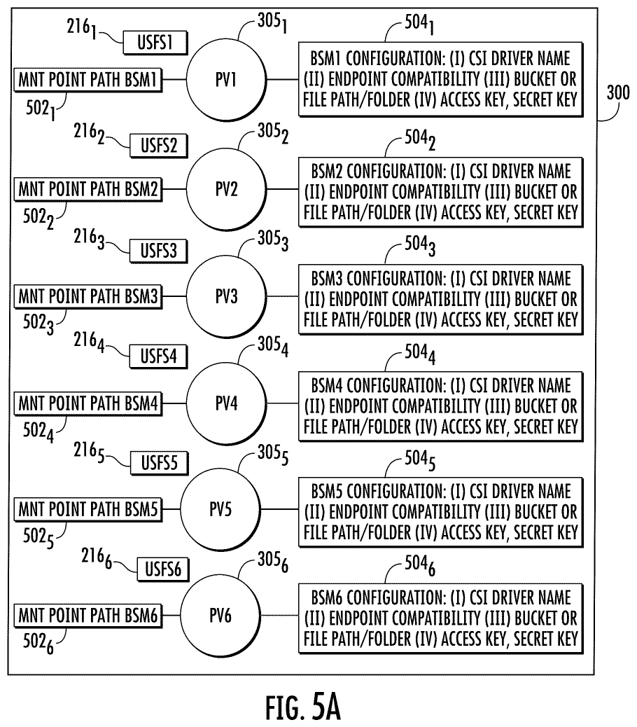

FIG. 5A is an illustrative drawing representing multiple PVs 305₁-305₆ configured within pod 300 that runs an AI application 302. Each PV 305₁-305₆ is associated with a different BSM 207₁-207₆. In this example, PV1 305₁ is associated with BSM 207₁; PV2 305₂ is associated with BSM 207₂; PV3 305₃ is associated with BSM 2073₁; PV4 305₄ is associated with BSM 207₄; PV5 305₅ is associated with BSM 207₅; and PV6 305₆ is associated with BSM 207₆. Each PV 305₁-305₆ is mounted at a different specific mount point path 502₁-502₆ and is associated with a different one of USFSs 216₁-216₆. Moreover, each respective PV 305₁-305₆ is associated with a different respective CSI instance (not shown) that mounts the respective PV at a different respective mount point path 502₁-502₆ and that instantiates and registers a different respective USFS 216₁-216₆ at the respective mount point path 502₁-502₆ for that respective PV 305₁-305₆ to intercept file operations issued at paths beneath it. For example, PV1 305₁ is mounted at mount point path 502₁, and USFS 216₁ is registered at mount point path 502₁.

Each of the PVs 305₁-305₆ is bound to a different BSM configuration 504₁-504₆, as specified in a pod specification for pod 300. More specifically, each BSM configuration 504₁-504₆ provides PV attributes: (i) a CSI driver name for the configuration, (ii) endpoint compatibility for the configuration, (ii) bucket or file path/folder, and (iv) access key, secret key. The endpoint compatibility attribute identifies the BSM associated with the PV. The bucket or file path/folder indicates file paths beneath a PV's mount point path. For example, the endpoint compatibility attribute in the BSM1 configuration 504₁ identifies BSM1 (e.g., 207₁), and the BSM4 configuration 504₄ identifies BSM4 (e.g., 207₄).

When a PV is created in a pod, backend storage configuration information that identifies the BSM to be used for file operations on the PV is included in the PV specification. This BSM configuration information comprises (i) a CSI driver name, (ii) an endpoint of the BSM, (iii) a bucket name or file/folder path within the BSM where the data resides, and (iv) access key and secret key credentials, as illustrated by BSM configurations 504₁-504₆ in FIG. 5A. When a CSI driver mounts the PV and instantiates a USFS associated with the PV at the mount point path, the CSI driver provides this BSM configuration information to the USFS. The USFS retains the BSM configuration information and, on each network API request that it subsequently sends to the SG, includes BSM-identifying information from that BSM configuration—namely, the endpoint of the BSM and the bucket name or file/folder path. Because the BSM-identifying information is carried in each request, the SG can determine which BSM to access from the request itself, without requiring a separate registry to indicate which USFS is associated with which PV.

For example, when PV1 305₁ is created in pod 300, BSM configuration 504₁ is included in the specification of PV1 305₁. BSM configuration 504₁ identifies BSM1 207₁ by including (i) the CSI driver name, (ii) the endpoint of BSM1 207₁, (iii) the bucket name or file/folder path within BSM1 207₁ at which the relevant model or dataset is stored, and (iv) the access key and secret key credentials. CSI 308₁ mounts PV1 305₁ at mount point path 502₁, instantiates USFS1 216₁ at mount point path 502₁, and passes BSM configuration 504₁ to USFS1 216₁. When AI application 302 subsequently issues a file operation on a file path beneath mount point path 502₁ (for example, /mnt/models/BSM1/model.bin), OS 324 intercepts the file operation and routes it to USFS1 216₁. USFS1 216₁ translates the file operation into a network API request, embeds in the request the endpoint and the bucket name or file/folder path from BSM configuration 504₁, and sends the network API request directly to SG1 214₁. SG1 214₁ reads the endpoint and the bucket name or file/folder path from the request, identifies BSM1 207₁ as the target, and uses APIlogic provided by multi-API logic 317 corresponding to BSM1 207₁ to communicate with BSM1 207₁ and complete the request.

An advantage of this framing is that the BSM-identifying information that is already present in the PV specification (e.g., the bucket name in the CSI volumeAttributes, the endpoint via mount options or volume attributes, the CSI driver name, and credentials referenced by the PV) flows naturally to the USFS at mount time and then accompanies each request to the SG. The SG therefore does not need to maintain a separate registry to associate requests with BSMs, since each network API request is self-describing.

FIG. 5B is an illustrative diagram representing an example process 500 to complete a file operation using the system of FIGS. 2-3. In operation 502, an OS kernel intercepts a file operation issued by an application. The OS kernel identifies a mount point path in the pathname of the file operation and invokes the USFS associated with that mount point path. In operation 504, the USFS translates the file operation to a network API request and sends the network API request to the SG.

In operation 506, SG attempts to complete the request by accessing the L1 cache. If there is a cache hit at the L1 cache, then control flows to operation 508, in which the SG sends return information from the L1 cache to USFS. Control next flows to operation 510, in which the USFS stores the return information in the PV mounted at the identified mount path point. If there is a cache miss at the L1 cache, then control flows to operation 512, in which the SG attempts to complete the request by accessing the L2 cache. If there is a cache hit at the L2 cache, then operation 514 stores the return information in the L1 cache and control flows to operation 508. If there is a cache miss at the L2 cache, then control flows to operation 516, in which the SG identifies a BSM that stores the file targeted by the intercepted file operation based on information.

In operation 516, SG identifies the BSM targeted by the file operation as described above. The SG accesses attribute information in the BSM configuration bound to the PV associated with the USFS that sent the request, to identify the BSM based on the endpoint compatibility attribute.

In operation 518, the SG redirects the request over an external network (such as the internet, for example) to the identified BSM. The SG uses an API protocol provided by the multi-API logic 317 to communicate with the identified BSM. The multi-API logic 317 is configured to implement a prescribed network API protocol for each of the BSMs 207₁-207₆ of the BSMS 207. Different BSMs may require different prescribed API protocols. An example multi-API logic includes an index logic to associate different ones of APIlogic₁-APIlogic₄ with different ones of BSM 207₁-207₆. An example multi-API logic can implement APIlogic₁-APIlogic₄. For example, BSM 207₁ may require AP1logic₁ for network communication, and BSM 207₄ and BSM 207₅ may require APIlogic₂ for network communication. The index logic structure is can be configured to associate BSM 207₁ with AP1logic₁ and to associate BSM 207₄ and BSM 207₅ with APIlogic₂.

Thus, in operation 516, the SG can determine which BSM to access to complete a request based on the USFS that sent the request to it, and in operation 518, the multi-API logic can implement an API required to communicate with the identified BSM. If there is no cache hit, then the SG redirects a request that it receives from a USFS over an external network to an identified BSM and uses an API protocol implemented using the multi-API logic 317 to communicate with the identified BSM over the network. Control flows to operation 508 once the SG receives return information from the identified BSM.

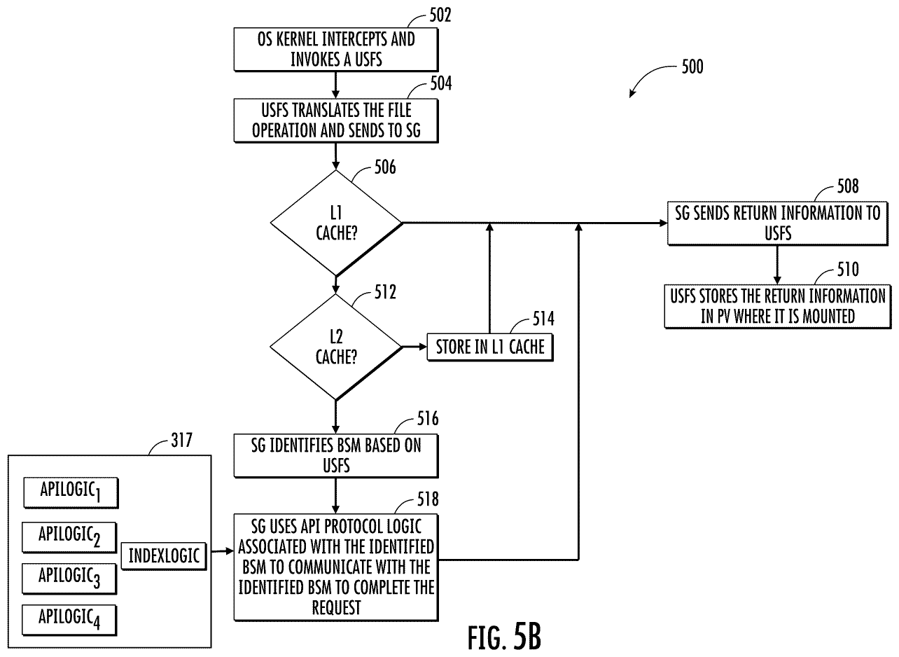

FIG. 6 is an illustrative drawing representing file 250 that the distributed computing system 200 can store to or retrieve from an L1 cache, an L2 cache, or a BSMS. File 250 includes a first section 252 that includes data representing a model or a dataset, for example. File 250 includes a second section, 254, containing metadata about the model or dataset. Metadata data can include logical identifiers such as a filename or path. Metadata can include location information such as block addresses. Metadata can include structure information such as file size, block list, or chunk mapping. An AI application 302 can issue a file operation that uses metadata to indicate a file or a portion of a file (e.g., a set of file block addresses) to retrieve from storage. Moreover, an example USFS 216₁ can handle a file operation that requests a file's metadata, such as a request to get a list of a file's directory information that identifies segmentable parts of a file, such as file blocks or sets of model weights or to get a file's attribute information such as size, location or organization of a files segmentable parts. For example, a USFS 216₁ can translate a file operation requesting certain parts of a file to a corresponding network API request (e.g., S3 ListObjects), and SG1 214₁ can use the network API request to get a list of the file's metadata. The metadata can be returned to application 302, which can, in turn, use it to request parts of a file rather than the entire file. The ability to specify parts of a file to access enables efficient incremental reads by fetching only the requested portions (e.g., blocks or sets of model weights) of a file, for example: bytes 0-1023 of model.bin. The decision of which file blocks (e.g., byte ranges) of a model or dataset to read can be made by an AI application 302, potentially after it has initially used a storage gateway instance SG1 214₁ to retrieve specific metadata from the file and has parsed the retrieved metadata to determine which segmentable portion of the file to read. With this approach, an AI application 302 can incrementally access information from a model or dataset that is too large to efficiently read all at once. This can improve processing efficiency when an application 302 runs very large models or processes very large data sets, since AI application 302 can read smaller chunks of the model or dataset and begin processing on these smaller chunks without the need to spend the time and processing resources to retrieve from a BSM an entire model or an entire data set before starting, for example.

### Example—Successive Reads of the Same Information

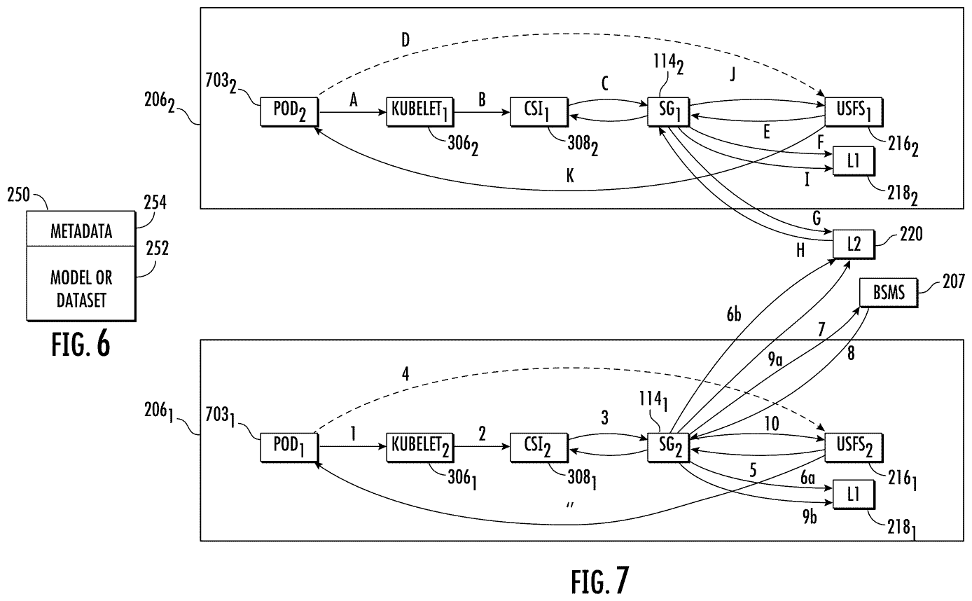

FIG. 7 is an illustrative function diagram 700 showing a succession of set up and read cycles involving the first worker node 206₁ and the second worker node 206₂. By way of overview, during a first set up and read cycle, a read command from a first pod 703₁ of the first worker node 206₁ results in cache misses at the first and second level caches 218₁, 220. During a second set up and read cycle, a read command from a second pod 703₂ of the second worker node 206₂ which sequentially occurs after the first read cycle, results in a miss at the first level cache 218₂ and a hit at the second level cache 220. In this example, the same information is requested in the first and second read cycles.

During a first set up process at the first worker node 206₁, a control plane node (not shown) places the first pod 703₁ running an AI application (e.g., inference, fine-tuning, or workload) onto the first worker node 206₁. At step 1 (Read model.bin), first Kubelet 306₁ running on the first worker node 206₁ reads the pod definition for the first pod 703₁ and at step 2 (Trigger NodePublishVolume), imparts a NodePublishVolume command to launch the first CSI driver 308₁ identified in the pod definition for the first pod 703₁. At step 3 (Instruct Gateway/Fuse), the first CSI driver 308₁ starts the first user-space filesystem instance 216₁ and establishes a communication path between the first user-space filesystem 216₁ and the first storage gateway instance 214₁. Subsequently, during a first read cycle, at step 4 a file operation involving a read, (read() syscall (Intercepted)), issued by an AI application running at the first pod 703₁ and having a PV mounted at/mnt/ . . . /models that identifies a file (e.g., model.bin), is intercepted by the first USFS 216₁. At step 5 (Request Bytes), the first USFS 216₁ uses the first file system access API logic 315₁ to send the read request to the SG1 214₁. At step 6a (Check L1 Cache), SG1 214₁ checks whether the first L1 cache 218₁ has the information identified in the read request. In this example, the first L1 cache 218₁ does not have the requested information (cache miss). So, at step 6b (Check L2 Cache), the first storage gateway instance 214₁ checks whether the shared L2 cache 220 has the information identified in the read request. In this example, the shared L2 cache 220 does not have the requested information (cache miss). So, at step 7 (Fetch block from BSMS), the first storage gateway instance 214₁ requests the information from BSMS 207. More particularly, the first storage gateway instance 214₁ uses a file name identified in the read file operation to select a BSMS (e.g. one of 207₁ to 207₆) that stores the identified file and uses an API corresponding to the selected BSMS to retrieve the requested information from the selected BSMS. At step 8 (Return Block), the BSMS 207 returns the requested information to the first storage gateway instance 214₁. At step 9a (Write Block to L2 Cache), the SG1 214₁ writes the requested information to the L2 cache 220. At step 9b (Write Block to L1 Cache), the SG1 214₁ writes the requested information to the first L1 cache 218₁. At step 10 (Return Requested Bytes), the SG1 214₁ returns the requested information to the first USP 216₁. At step 11 (Return data to Pod), the first USPS 216₁ returns the requested information to the requesting AI application at the first pod 703₁.

During a second set up process at the second worker node 206₂, a control plane node (not shown) places the second pod 703₂ running an application (e.g., inference, fine-tuning, or workload) onto the second worker node 206₂. At step A (Read model.bin), second Kubelet 306₂ running on the second worker node 206₂ reads the pod definition for the second pod 703₂ and at step B (Trigger NodePublishVolume), imparts a NodePublishVolume command to launch the second CSI driver 308₂ identified in the pod definition for the second pod 703₂. At step C (Instruct Gateway/Fuse), the second CSI driver 308₂ starts the second user-space filesystem instance 216₂ and establishes a communication path between the second USFS 216₂ and the SG2 214₂. Subsequently, during a second read cycle, at step D (read() syscall (Intercepted)), an application having a PV (not shown) mounted at/mnt/ . . . /models and which is running at the second pod 703₂ issues a read file operation that identifies a file (e.g., model.bin), which is intercepted by the first USFS 216₂. At step E (Request Bytes), the second USFS 216₂ uses a second file system access API logic (not shown) to send the read request to the second storage gateway instance 214₂. At step F (Check L1 Cache), the SG2 214₂ checks whether the second L1 cache 218₂ has the information identified in the read request. In this example, the second L1 cache 218₂ does not have the requested information (cache miss). So, at step G (Check L2 Cache), SG2 214₂ checks whether the shared L2 cache 220 has the information identified in the read request. In this example, the shared L2 cache 220 does have the requested information (cache hit), since the SG1 214₁ caused the information to be stored in the L2 cache 220 during the first read cycle. So, at step H (Read Block from L2 Cache), SG2 214₂ retrieves the requested information from the shared L2 cache 220. At step I (Write Block to L1 Cache), the second storage gateway instance 214₂ writes the requested information to the second L1 cache 218₂. At step J (Return Requested Bytes), the second storage gateway instance 214₂ returns the requested information to the second USFS 216₂. At step K (Return Data to Pod), the second USPS 216₂ returns the requested information to the requesting application at the second pod 703₂.

FIG. 8 is an illustrative drawing representing a computing machine 800 that can be a compute instance that can be configured to operate as a cluster node, either as a control cluster node 1041-1043 or as a worker node 106₁ or 106₂ of the cluster 102 of FIG. 1, or as a control cluster node 204 or as a worker node 206₁-206₃ of the cluster 202 of FIG. 2. It will be understood that although only one example machine 800 is shown, each of the nodes 104₁-104₃, 106₁-106₂, 204 and 206₁-206₃ can run on a different instance of machine 800. Machine 800 comprises a computer system within which a set of instructions may be executed for causing machine 800 to perform any one or more of the methodologies discussed herein. Machine 800 can be implemented as a physical machine or as a virtual machine (VM). Instructions 816 (e.g., software, computer program code, or other executable code) may cause an example machine 800 to implement operations of the API server 105₁, scheduler 117₁, kube controller manager server 115₁, etcd store 118₁, SG1-SG3, USPS 216₁-216₂, kubelet 122₁, a kube proxy server 124₁, and pods 130 and 300,, which can run one or more containers 132₁. The instructions 816 include an operating system 324 responsible for low-level system services, including process management, memory management, device management, and system calls. The operating system 324 can respond to instructions provided by higher-level computer programs, such as service mesh clients, service mesh servers, and containerized applications. The operating system 324 can include VFS 322. In this way, instructions 816 may transform a general, non-programmed machine 800 into a particular machine (e.g., a control plane node or a worker node in a Kubernetes cluster) that is specially configured to carry out any one of the described and illustrated functions in the manner described herein.

An example computing machine 800 includes one or more machine-level processing components 811, machine-level memory 830, and input/output (I/O) components 850 configured to communicate with each other, such as via a bus 802. Example machine-level processing components 811 can include one or more of (e.g., a central processing unit (CPU), a reduced instruction set processing (RISC) processor, a complex instruction set processing (CISC) processor, a graphics processing unit (GPU), a digital signal processor (DSP), an application-specific integrated circuit (ASIC), or another processor, or any suitable combination thereof). Example memory 830 comprises a non-transitory computer-readable storage medium that may include a main memory 832, a static memory 834, and a storage unit 836, all accessible to one or more machine-level processing components 211, such as via bus 802, to store the executable instructions or code 816. Machine-level processing components 811 can be configured to execute code stored in machine-level memory 830, to perform operations to implement Kubernetes components described herein. Example input components 854 (of the I/O components 850) may also include one or more of a keyboard, mouse, buttons, gesture input, or other input signal sensors. Example output components 852 (of the I/O components 850) may include a display screen, speakers, or other output signal generators. Example I/O components 850 may include a network interface 864 to couple the machine 800 with a network 113. Network interface components can include one or more wired, wireless, cellular, or near-field interface components. An example network interface supports communication using a network protocol, such as HTTP.

### Example—GPU Auto Scaling

GPU auto scaling typically involves adding new instances of pods, and sometimes GPU-based worker nodes, to share the processing of an AI inference application. This spreading of processing effort over a larger collection of compute resources (e.g., pods) can achieve processing speed gains. The new pods must load (i.e., read from memory) models used by the AI inference application. Models typically are large and can be time-consuming to load into the new pods. For example, models like DeepSeek R1 671B model can be around 720 GB, Llama 2 70 GB around 130 GB, and even smaller models like Stable Diffusion checkpoints are often 4-7 GB. In the past, a new pod containing a new AI application added during GPU auto scaling often was required to download an entire massive model file before starting to work, which can make GPU auto scaling a slow process.

The distributed computing system 200 can speed the GPU auto scaling process by obviating the need for the newly added pods to load the models upfront before they start processing an AI application that uses the model. Instead, for example, the newly added pod can retrieve the model or parts thereof from a local L1 cache 218₁ or from a shared L2 cache 220 rather than downloading the model from a BSMs 207.

Alternatively, for example, a new AI application on worker node 206₁ can download and store metadata from a file that contains a model to be used by the new AI application to a local L1 cache 218₁ or from a shared L2 cache 220 without downloading the entire model file and retrieving it from a local L1 cache 218₁ or from a shared L2 cache 220. The AI application then can use the model file's metadata to identify a small portion of a model needed to start processing (e.g., bytes 0-1023 of model.bin). The AI application can retrieve small portions of a model's file incrementally from the BSMS 207 as needed to process the AI application. As a result, the amount of compute resources available to process an AI workload can scale up to meet demand much faster because the new pods can start work using small portions of a model from a low-latency cache instead of waiting to retrieve an entire model from a higher-latency backend storage memory system.

### Example—Checkpoints

A model's weights, biases, and other parameters are adjusted during fine-tuning. A “checkpoint” is a saved state of the model during fine-tuning that can include the model's weights, biases, and other parameters at a specific point in time. A checkpoint can allow a long-running fine-tuning application to reliably resume training from a specific point in a fine-tuning process without starting over. A checkpoint can allow deployment of a model for inference if the checkpoint represents a well-performing state. A checkpoint can ensure recovery from interruptions such as a GPU node failure. In the past, saving checkpoints during model training often involved writing huge files, which can pause expensive GPUs. Moreover, loading these checkpoints back to a model training application often required significant time. In distributed computing system 200, a fine-tuning AI application can cause a storage gateway to periodically rapidly save the checkpoint to a fast local (L1) cache and/or a shared (L2) cache. The AI application running in a pod could return to fine-tuning after storing the checkpoint to L1 and L2 caches, while the storage gateway uploads the checkpoint in a background process to a backend storage memory system. Alternatively, the AI application running in a pod can return to fine-tuning after storing the checkpoint to the L1 cache, while the storage gateway uploads the checkpoint in background processes to the L2 cache and the backend storage memory system. Reduced time required for saving and retrieving checkpoints during fine-tuning can result in better GPU utilization and faster overall training cycles. Moreover, a checkpoint of a model in a well-performing state can be rapidly deployed from L1 cache to a local worker node and from an L2 cache to different worker node without the delay required to upload the checkpoint from a backend storage memory system.

### Example—Versioning

Different versions of a model or dataset can refer to distinct snapshots in time of a model or dataset. For example, a first version of a dataset may set forth weather reports trends through February 2025. A second version of the same dataset may set forth weather report trends through March 2025. Managing different versions of models or datasets (like model_v1, model_v2) can be difficult. In the past, switching between different versions of a model or dataset to be used by an inference or fine-tuning application often required downloading an entire version of the model or dataset, which can consume significant time and processor resources (e.g., processor cycles). The distributed computing system 200 can set up different instances of an application in different pods so that a first instance of an application running in a first group of pods sees a first version of a model or dataset in their/mnt/models folder, and a second instance of an application running in a second group of pods sees a second version of the model or dataset in their/mnt/models folder. The distributed computing system 200 handles pointing the respective /mnt/models folders of the first and second groups of pods to the correct files in L1 cache, L2 cache, and BSMS. A PV for a pod that runs a first instance of an application can be mounted to a path that the SG can use to point to first memory locations in L1 cache, L2 cache, and the BSMS. For example, a PV 305₁ of a pod that runs a first instance of an application can be mounted to a first path that SG 214₁ can use to point to first memory locations in L1 cache, L2 cache, and the BSMS. For example, a PV 305₁ of a pod that runs a second instance of an application can be mounted to a second path that SG 214₁ can use to point to second memory locations in L1 cache, L2 cache, and the BSMS. Thus, instead of downloading different versions of a model or data set, different instances of an application are provisioned that see different versions of the model or dataset. Moreover, suppose many instances of an AI application running on different pods run the same version (e.g., v2). In that case, they all can benefit from using a shared L2 cache, avoiding downloading v2 over and over from a backend storage memory system. Different sets of pods or worker nodes that run different versions of a model can share different L2 caches, such that the different pods or worker nodes each use a different L2 cache to access their version of a model. Thus, different versions of a model to dataset can be more easily deployed, and popular versions can load efficiently for multiple pods or users.

The above description is presented to enable any person skilled in the art to create and run a system and method to access AI models and datasets in Kubernetes. Various modifications to the embodiments will be readily apparent to those skilled in the art, and the generic principles defined herein may be applied to other embodiments and applications without departing from the spirit and scope of the invention. In the preceding description, numerous details are set forth for the purpose of explanation. However, one of ordinary skill in the art will realize that the embodiments in the disclosure might be practiced without the use of these specific details. In other instances, well-known processes are shown in block diagram form in order not to obscure the description of the invention with unnecessary detail. Identical reference numerals may be used to represent different views of the same or similar item in different drawings. Thus, the foregoing description and drawings of examples in accordance with the present invention are merely illustrative of the principles of the invention. Therefore, it will be understood that various modifications can be made to the embodiments by those skilled in the art without departing from the spirit and scope of the invention, which is defined in the appended claims.

1. A distributed computing system to run an application that uses information stored in one or backend storage memories (BSMs) that use different application programming interfaces (APIs) to provide access to the stored information over a network, comprising:
a cluster; and
a Level two (L2) cache;
wherein the cluster comprises:
multiple worker nodes;
wherein each worker node of the multiple worker nodes includes,
a Level one (L1) cache;
one or more pods that include one or more containers configured to run,
a storage gateway (SG);
multi-API logic; and
wherein the SG running on each worker node is configured to return information from one of the L1 cache, the L2 cache, and a BSM, based on a file operation issued by an application running on that worker node; and
wherein the multi-API logic running on each worker node is configured to a BSM API of multiple BSM APIs to return information to the SG from a BSM.

2. The distributed computing system of claim 1,
wherein the SG running on each worker node is configured to have exclusive use of the L1 cache running at that worker node; and
wherein the SG running on each worker node is configured to share the L2 cache with other worker nodes of the cluster.

3. The distributed computing system of claim 1,
wherein the SG running on each worker node is configured to,
attempt to use the L1 cache on that worker node to provide return information based on a file operation issued by an application running on that cluster worker node,
based on a cache miss at the L1 cache, attempt to use the L2 cache to provide return information based on a file operation issued by an application running on that cluster worker node, and
based on a cache miss at the L1 cache and the L2 cache, use a BSM to provide return information based on a file operation issued by an application running on that cluster worker node.

4. The distributed computing system of claim 3,
wherein the SG running on each worker node is configured to store in the L1 cache on that worker node, information returned to an application running on that worker node based on a cache hit at the L2 cache based on a file operation issued by an application running on that cluster worker node; and
wherein the SG running on each worker node is configured to store in the L1 cache on that worker node and in the L2 cache, information returned to an application running on that worker node from a BSM based on a file operation issued by an application running on that cluster worker node.

5. The distributed computing system of claim 1,
wherein the multiple worker nodes further include,
a filesystem;
wherein the filesystem on each worker node is configured to receive a file operation issued by the application running on that cluster worker node, to receive return information from the SG running on that cluster worker node and provide the return information to the application running on that cluster worker node.

6. The distributed computing system of claim 5,
wherein the filesystem on each worker node is configured to receive a file operation intercepted by an operating system kernel of the worker node where the filesystem runs.

7. The distributed computing system of claim 5,
wherein the filesystem on each worker node is configured to translate a file operation issued by an application running on the worker node where the filesystem runs to a network API request; and
wherein the SG on each worker node is configured to return information from one of the L1 cache, the L2 cache, and a BSM based on a network API request produced by a filesystem running on that worker node.

8. The distributed computing system of claim 7,
wherein the SG running on each worker node is configured to,
attempt to use the L1 cache on that worker node to provide return information based on a network API request produced by a filesystem running on that cluster worker node,
based on a cache miss at the L1 cache, attempt to use the L2 cache to provide return information based on a network API request produced by a filesystem running on that cluster worker node, and
based on a cache miss at the L1 cache and the L2 cache, use a BSM to provide return information based on a network API request produced by a filesystem running on that cluster worker node.

9. The distributed computing system of claim 8,
wherein the SG running on each worker node is configured to store in the L1 cache on that worker node, information returned to an application running on that worker node based on a cache hit at the L2 cache based on a network API request issued by the filesystem running on that cluster worker node; and
wherein the SG running on each worker node is configured to store in the L1 cache on that worker node and in the L2 cache, information returned to an application running on that worker node from a BSM based on a network API request produced by the filesystem running on that cluster worker node.

10. The distributed computing system of claim 9,
wherein the filesystem on each worker node is configured to receive a file operation intercepted by an operating system kernel of a worker node where the filesystem runs.

11. A distributed computing system, comprising:
a cluster including at least one worker node;
a pod running on the worker node, the pod including one or more containers configured to execute an application;
a plurality of persistent volumes (PVs) associated with the pod, each PV of the plurality of PVs being:
(i) mounted at a different mount point path within a filesystem namespace of the pod, and
(ii) bound to a different backend storage configuration that identifies a corresponding backend storage memory;
a plurality of user-space filesystem (USFS) instances, each USFS instance corresponding to a respective one of the plurality of PVs and registered to intercept file operations issued at file paths beneath the mount point path at which the respective PV is mounted; and
a storage gateway (SG) communicatively coupled to the plurality of USFS instances;
wherein:
a file operation issued by the application at a file path beneath a mount point path is intercepted by the USFS instance corresponding to the PV mounted at that mount point path;
the USFS instance translates the file operation into a network API request and forwards the network API request to the storage gateway; and
the storage gateway identifies the backend storage memory to service the network API request based on the backend storage configuration bound to the PV corresponding to the USFS instance that forwarded the network API request, and uses the identified backend storage memory to complete the file operation.

12. A method of auto scaling an inference application that runs in a distributed computing system comprising a cluster that includes multiple worker nodes, comprising:
running a first pod on a first worker node in the cluster that includes one or more containers used to execute a first instance of an inference application;
accessing a backend memory system (BMS) by the first instance of the first inference application to obtain return information from the BMS that includes at least a portion of a model;
storing the at least a first portion of the model in a first cache exclusively accessible to pods running on the first worker node;
using the at least a portion of the first model by the first instance of the inference application during execution of the first instance of the inference application;
while the first instance of the inference application is executing in the first pod on the first worker node, spinning up a second pod on the first worker node that includes one or more containers used to execute a second instance of the inference application in the first pod on the first worker node;
accessing the first cache by the second instance of the inference application to obtain return information from the first cache that includes the at least a portion of the first model; and
using the at least a portion of the first model by the second instance of the inference application during execution of the second instance of the inference application in the second pod on the first worker node.

13. A method of auto scaling an inference application that runs in a distributed computing system comprising a cluster that includes multiple worker nodes, comprising:
running a first pod on a first worker node in the cluster that includes one or more containers used to execute a first instance of an inference application;
accessing a backend memory system (BMS) by the first instance of the first inference application to obtain return information from the BMS that includes at least a portion of a model;
storing the at least a first portion of the model in a second cache configured to be accessible to each worker node of the cluster;
using the at least a portion of the model by the first instance of the inference application during execution of the first instance of the inference application in the first pod on the first worker node;
while the first instance of the inference application is executing in the first pod on the first worker node, spinning up a second pod on a second worker node that includes one or more containers used to execute a second instance of the inference application in the second pod;
accessing the second cache by the second instance of the inference application to obtain return information from the second cache that includes the at least a portion of the model; and
using the at least a portion of the model by the second instance of the inference application during execution of the second instance of the inference application in the second pod on the second worker node.

14. A method of checkpointing a fine-tuning application that runs in a distributed computing system comprising a cluster that includes multiple worker nodes, comprising:
running a pod on a worker node in the cluster that includes one or more containers used to execute the fine-tuning application to fine-tune a model;
while a first instance of the fine-tuning application is executing in the pod on the worker node, periodically storing a checkpoint of the model in a cache memory;
while the first instance of the fine-tuning application is executing in the pod on the worker node, uploading the checkpoint from the cache to a backend storage memory (BSM).

15. The method of checkpointing a fine-tuning application of claim 14,
spinning up a second pod on a second worker node that includes one or more containers used to execute a second instance of the fine-tuning application in the second pod on the second worker node;
using the checkpoint of the model by the second instance of the fine-tuning application during execution of the second instance of the inference application in the second pod on the second worker node.

16. The method of checkpointing a fine-tuning application of claim 15,
wherein the cache memory is configured to be accessible to each worker node of the cluster; and further including:
accessing the cache memory by the second instance of the fine-tuning application to obtain return information that includes the checkpoint of the model from the cache memory; and
using the checkpoint of the model by the second instance of the fine-tuning application during execution of the second instance of the fine-tuning application in the second pod on the second worker node.

17. A distributed computing system to use an application to process different versions of a model or dataset stored at a backend storage system, comprising:
a cluster comprising:
a first pod that includes a first persistent volume (PV) mounted to a first mount point path and that includes one or more containers configured to execute a first instance of an application; and
a second pod that includes a second persistent volume (PV) mounted to a second mount point path and that includes one or more containers configured to execute a second instance of the application;
a storage gateway (SG);
wherein the SG is configured to return information from a first memory location in a BSMS in response to a file operation issued by the first instance of an application; and
wherein the SG is configured to return information from a second memory location in the BSMS in response to a file operation issued by the second instance of the application.

18. The distributed computing system of claim 17 further including:
cache memory;
wherein the cluster includes multiple worker nodes;
wherein the first pod and the second pod run on the same worker node;
wherein the SG runs in a pod on each worker node; and
wherein the SG running on each worker node is configured to return information from one of a first memory location of the cache memory and a first memory location in the BSMS in response to a file operation issued by the first instance of an application; and
wherein the SG running on each worker node is configured to return information from one of a second memory location of the cache memory and a second memory location in the BSMS in response to a file operation issued by the second instance of an application.

19. The distributed computing system of claim 18,
wherein the SG running on each worker node is configured to,
attempt to use the cache memory to provide return information in response to a file operation issued in response to a file operation issued by the first instance of the application,
based on a cache miss in response to the file operation issued by the first instance of the application, use the BSMS to provide return information in response to the file operation issued by the first instance of the application;
attempt to use the cache memory to provide return information in response to a file operation issued in response to a file operation issued by the second instance of the application; and,
based on a cache miss in response to the file operation issued by the second instance of the application, use the BSMS to provide return information in response to the file operation issued by the second instance of the application.

20. The distributed computing system of claim 19,
wherein the SG running on each worker node is configured to store in the cache memory, information returned to the first instance of the application from the BSMs in response to the file operation issued by the first instance of the application; and
wherein the SG running on each worker node is configured to store in the cache memory, information returned to the second instance of the application from the BSMs in response to the file operation issued by the second instance of the application.
